(19) United States
(12) Patent Application Publication
(10) Pub. No.: US 2022/0178766 A1
(43) Pub. Date: Jun. 9, 2022

(54) COLOR-CHANGING TEMPERATURE RING FOR BEVERAGE CONTAINERS

(71) Applicant: Pierre Maurice Baston, Emmaus, PA (US)

(72) Inventor: Pierre Maurice Baston, Emmaus, PA (US)

(21) Appl. No.: 17/546,889

(22) Filed: Dec. 9, 2021

Related U.S. Application Data
(60) Provisional application No. 63/123,077, filed on Dec. 9, 2020.

(51) Int. Cl. G01K 11/12; B65D 23/00; B65D 81/38

(52) U.S. Cl. CPC G01K 11/12; B65D 2203/12; B65D 81/3837; B65D 23/00

(57) ABSTRACT

A beverage serving system is disclosed having features for indicating the temperature of a beverage inside prior to consumption. In an embodiment, a thermochromic ring may visually indicate the temperature of the beverage to a user. A thermochromic ring in a window to offer a colorful 360° display that can be read at a glance from across a room. In embodiments of the invention, thermochromic material can be reversibly attached. In an embodiment, a thermal gap may be incorporated adjacent the thermochromic ring to expedite thermal transfer during temperature monitoring.

### REFERENCE TO RELATED APPLICATIONS

This application claims priority to U.S. patent application Ser. No. 63/123,077, filed Dec. 9, 2020, and titled, “ADVANCED BEVERAGE CONTAINER,” the contents of which is incorporated by reference in its entirety.

### BACKGROUND

A need exists for signaling the temperature of a beverage inside a beverage container to a consumer prior to drinking. Drinking a hot beverage from a travel mug, for example, has long vexed consumers who risk burning their tongues when they take a first sip from a mug, but do not know if the coffee or tea inside has cooled enough for safe drinking.

Some examples of prior art show beverage temperature by electronic display, but such “smart” mugs are expensive and can be complicated to use. Electronic temperature displays also consume electrical energy and may employ chemical batteries—both, factors that have negative environmental consequences.

Cups, tumblers, and mugs have also been proposed, which are painted with or incorporate thermochromic material that changes color in response to temperature changes, and in that way indicates beverage temperature. However, the prior art does not teach how to practically employ thermochromic material to tell the temperature of beverages in vacuum-insulated containers.

Vacuum-insulated vessels typically enclose the beverage in vacuumized double walls of stainless steel to prevent heat loss, but thermochromic temperature signaling requires the thermochromic material to be both in thermal contact with the beverage and visible to the user on the container's exterior. Since stainless steel is opaque, the thermochromic paint would have to be placed in a spot on the container's exterior that is not vacuum insulated. The vessel's ability to keep beverage hot would consequently be impaired.

Another problem with thermochromic temperature displays in prior art is that thermochromic material tends to lose its color-changing capacity over time as it is degraded by exposure to light.

The embodiments disclosed herein answer the need for an easy-to-use, eco-friendly, and cost-effective means for telling the temperature of a beverage inside an insulated container without compromising the vessel's insulating efficacy, and while sustaining a long functional life.

### BRIEF DESCRIPTION OF THE DRAWINGS

The features and advantages of the present disclosure will be more fully understood with reference to the following detailed description when taken in conjunction with the accompanying figures, wherein:

FIG. 1A illustrates a cross-sectional view of a vessel according to one or more embodiments;

FIG. 1B illustrates a cross-sectional view of the top of a vessel with the ring exposed according to one or more embodiments;

FIG. 2A illustrates the exterior of a vessel with a ring covered according to one or more embodiments;

FIG. 2B illustrates the exterior of a vessel with a ring exposed according to one or more embodiments;

FIG. 2C illustrates the exterior of the top of a vessel with a ring showing a different color according to one or more embodiments;

FIG. 3A illustrates a cross-sectional view of a vessel with a ring covered according to one or more embodiments;

FIG. 3B illustrates a cross-sectional view a of vessel with a ring exposed according to one or more embodiments;

FIG. 4A illustrates a cross-sectional view of a vessel with a ring covered according to one or more embodiments; and

FIG. 4B illustrates a cross-sectional view of a vessel with a ring exposed according to one or more embodiments.

### SUMMARY

In some aspects, the techniques described herein relate to a system that indicates the temperature of beverage inside a beverage container including: a container configured to hold a liquid to be consumed; a thermochromic material in thermal contact with the liquid; a chromatic member configured to reversibly (a) cover and (b) expose the thermochromic material to external view when engaged by a user.

In some aspects, the techniques described herein relate to a system further wherein a thermal member is configured to conduct thermal energy from the interior of the container to the exterior of the container without opening the liquid to the environment.

In some aspects, the techniques described herein relate to a system for accelerating the cooling of hot beverage inside a beverage container included by: a container configured to hold a liquid to be consumed; a thermal member that reversibly enhances or reduces thermal insulation of the container by covering or exposing at least a portion of the container without opening the liquid to the external environment.

In some aspects, the techniques described herein relate to a system which is further included by: a thermochromic material that is in thermal contact with the liquid; and a chromatic member configured to reversibly (a) cover and (b) expose the thermochromic material to external view when engaged by a user.

In some aspects, the techniques described herein relate to a system wherein the chromatic member and thermal member include the same component.

In some aspects, the techniques described herein relate to a system wherein the thermochromic material is reversibly attached.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention.

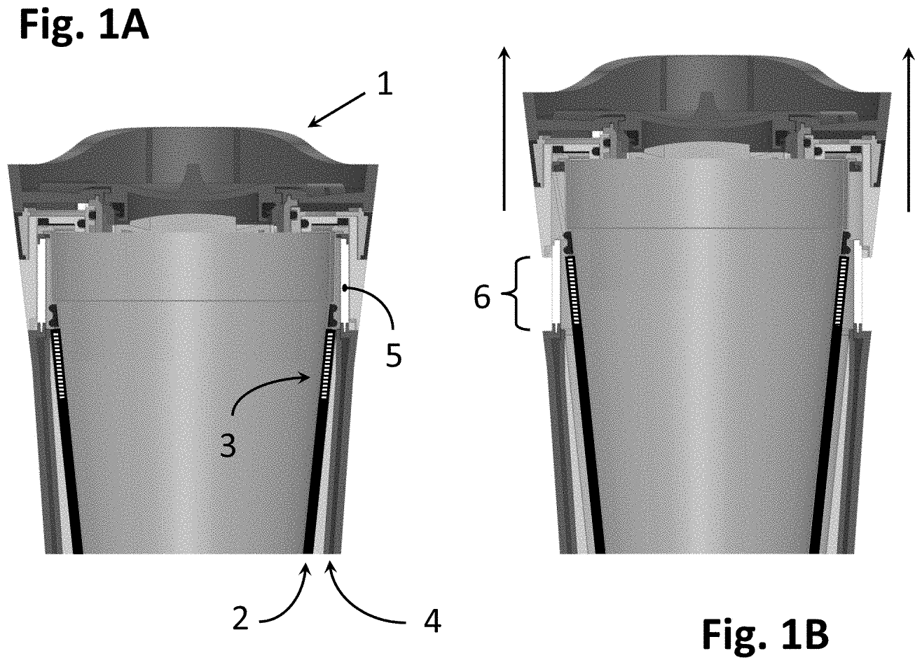

FIG. 1A illustrates a top part of an embodiment of the invention configured as a travel mug, which may comprise a vessel cap 1, an inner wall 2 which may be configured to contain a beverage, a ring 3 of thermochromic paint or other thermochromic material applied to an area of the outward-facing surface of inner wall 2, outer wall 4, and a transparent window 5 attached to the top of outer wall 4. The top section and sidewall of vessel cap 1 may be at least partly of stainless steel and double-walled, and the space between the cap's double walls may be vacuumized or otherwise insulated. Inner wall 2 and outer wall 4 may be of stainless steel. Outer wall 4 may be a double wall and may be vacuumized or otherwise insulated. Window 5 may extend outer wall 4 and may be made of any suitable transparent material like, for example, polycarbonate or glass. Because both the sidewall of vessel cap 1 and outer wall 4 are insulated, the vessel is completely insulated in FIG. 1A, and the beverage stays hot. The thermochromic ring 3 may be shielded from the degrading effects of light by the sidewall of vessel cap 1.

FIG. 1B illustrates an embodiment in which vessel cap 1 and the attached inner wall 2 may be raised relative to outer wall 4 and window 5 and thermochromic ring 3 is opposite window 5 and visible to the user through ring opening 6. Since inner wall 2 is in direct contact with the beverage, and thermochromic ring 3 is in direct contact with inner wall 2, thermochromic ring 3 will change colors as the temperature of the beverage changes.

Users may choose to raise the vessel cap to the position shown in FIG. 1B briefly, to check beverage temperature when desired, and then close the mug to the position shown in FIG. 1A again to preserve beverage temperature and the life of the thermochromic paint.

In an embodiment, when the user wishes to speed the beverage-cooling process in order to be able to drink safely sooner, the user can leave thermochromic paint ring 3 exposed as in FIG. 1B. In this position, the area of inner wall 2 painted by thermochromic ring 3 is covered by neither insulated outer wall 4 nor the insulated sidewall of vessel cap 1. As a result, the beverage inside inner wall 2 will cool more quickly as heat escapes through the thermal gap of window 5. Reducing the vessel's insulating efficacy in this case is purposeful and advantageous.

The user can monitor beverage-cooling by glancing at thermochromic ring 3 through window 5 from time to time. In an embodiment, a ring may offer a colorful 360° display that can be read at a glance from across a room. When ring 3 changes color to show that the beverage has cooled to safe drinking temperature, the user can close the mug to the position of FIG. 1A to reestablish maximum insulation that will keep his beverage at optimum temperature while he drinks them. Closing the mug at this point may also preserve the life of the thermochromic paint until the temperature-telling function is needed again for the next beverage serving.

Until now, users wishing to drink a hot beverage sooner from their insulated travel mugs have typically removed the travel-mug lid to speed cooling. In embodiments of the present invention, faster beverage cooling is available without opening the mug and without the attendant risk of spills.

In an embodiment, the useful life of the thermochromic feature is extended significantly. Tests have shown that thermochromic paint can maintain its ability to change color in response to temperature for up to 1 month, or about 400 hours of cumulative exposure to direct sunlight. After that, the paint's thermochromic quality can be lost. A one-month functional life for this feature would not be satisfactory to a user. In contrast, however, if a consumer used this invention to cool and monitor the temperature of a hot beverage for 30 minutes each day and closed the travel mug to shield thermochromic ring 3 from light when not in use, the user could enjoy the thermochromic color-changing function every day for more than 2 years. Some embodiments of this invention may provide removably attachable thermochromic tape, or another interchangeable thermochromic medium, that will allow users to replace the expired thermochromic material in thermochromic ring 3 with fresh thermochromic material whenever needed.

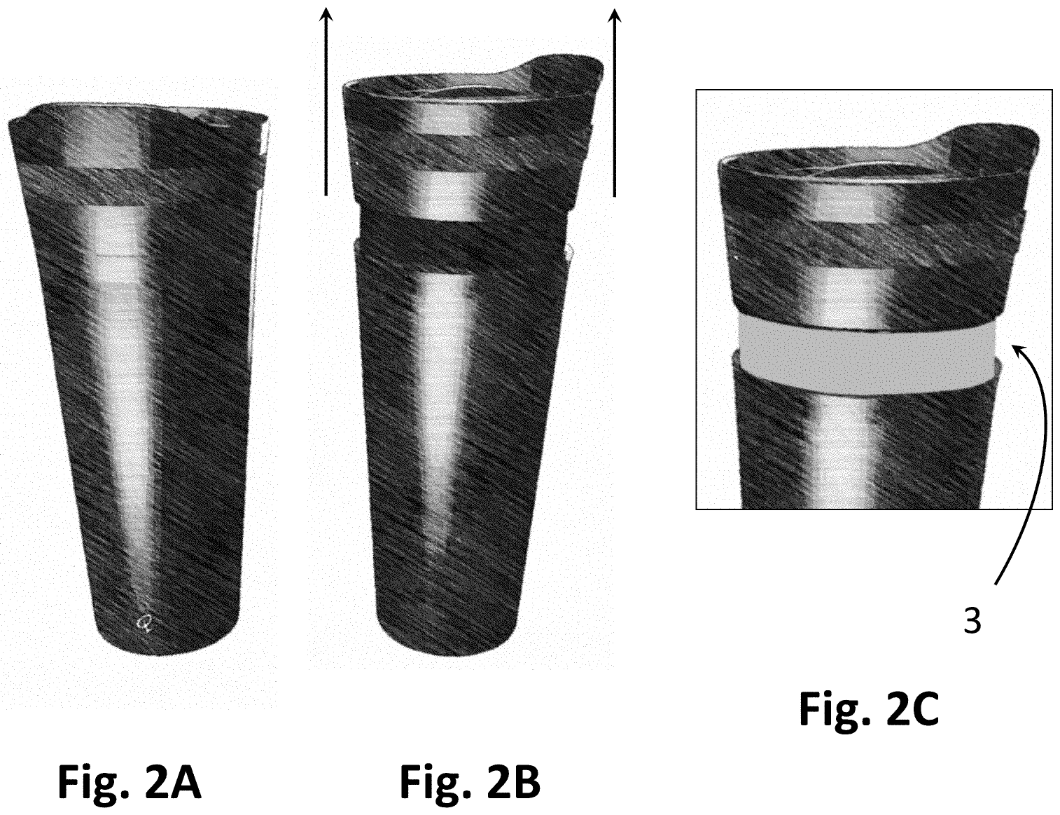

FIGS. 2A-2C illustrate exterior views of the embodiment shown in cross section in FIG. 1A and FIG. 1B. In FIG. 2A, the travel mug is depicted closed and fully insulated. In FIG. 2B, the mug's cap is depicted in a raised configuration to reveal thermochromic ring 1. FIG. 2C illustrates how thermochromic ring 1 will change from its resting color to a different color when beverage too hot to drink is poured into the vessel. The ring will change back again to its original color when the beverage has cooled to a safe drinking temperature.

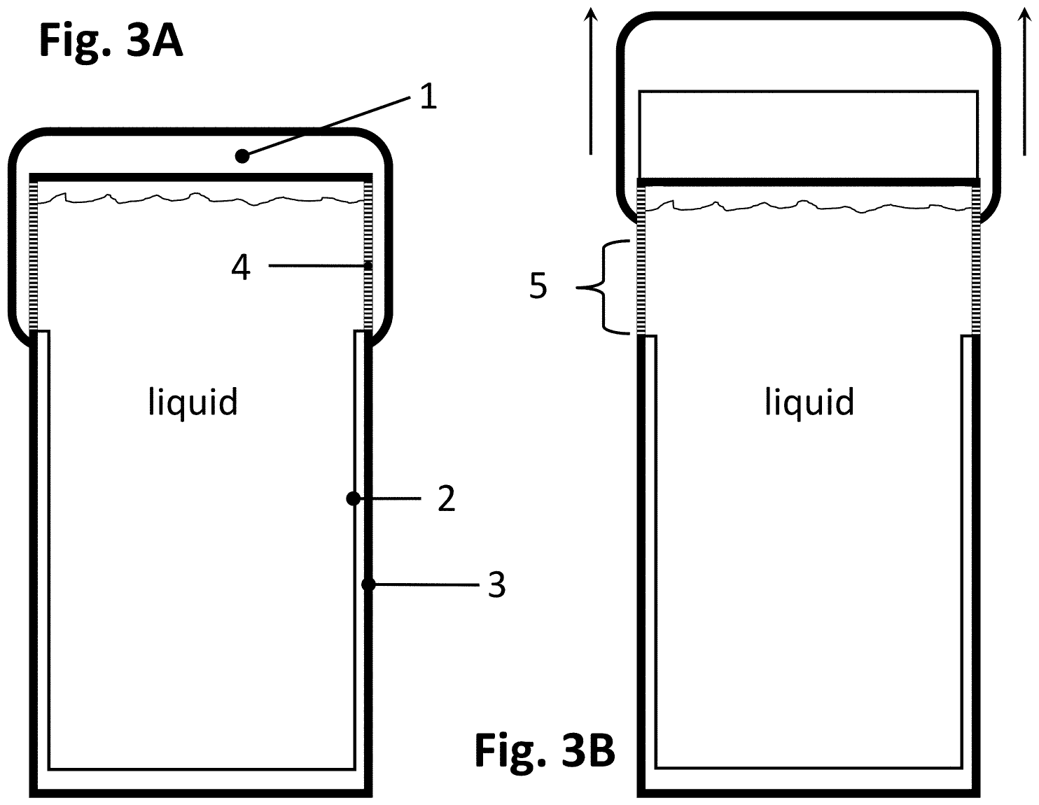

An alternative embodiment of this invention is illustrated in FIGS. 3A and 3B. FIG. 3A shows an embodiment configured as a travel mug comprised by vessel cap 1, inner wall 2, outer wall 3, and a ring 4 of thermochromic paint or other thermochromic material applied to an area of the outward-facing surface of outer wall 3. In this embodiment, the top section and sidewall of vessel cap 1 may be at least partly of stainless steel and double-walled, and the space between the cap's double walls may be vacuumized or otherwise insulated. Inner wall 2 and outer wall 3 may be of stainless steel, and the space between them may be vacuumized or otherwise insulated so as to form an insulated double wall. As shown in FIG. 3A, the beverage in the vessel is completely insulated all around, and thermochromic ring 4 is covered by the sidewall of vessel cap 1.

In FIG. 3B, vessel cap 1 is depicted in a raised configuration relative to inner wall 2 and outer wall 3, and thermochromic ring 4 is now revealed to view through gap 5. In this position, ring 4 indicates the temperature of the beverage inside the mug, and the beverage cools through the single-walled gap 5 created between the insulated sidewall of vessel cap 1 and the insulated double wall formed by inner wall 2 and outer wall 3.

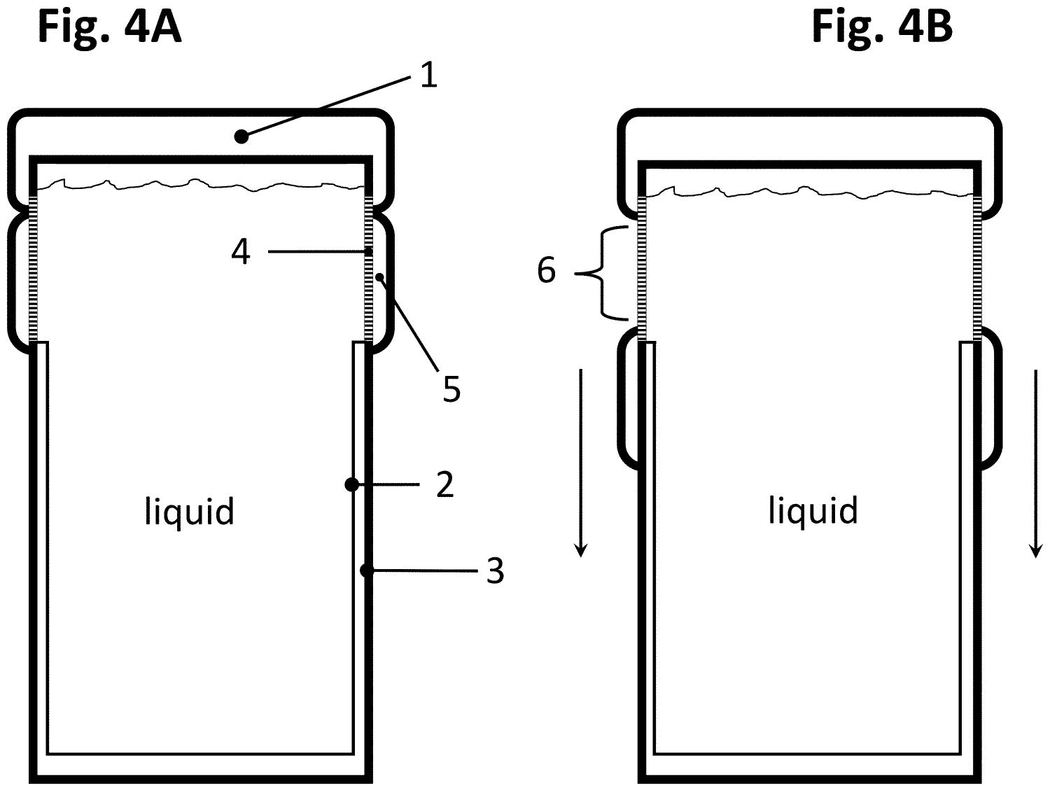

In another alternative embodiment, shown in FIGS. 4A and 4B, the vessel is comprised by vessel cap 1, inner wall 2, outer wall 3, a ring 4 of thermochromic paint or other thermochromic material applied to an area of the outward-facing surface of outer wall 3, and sleeve 5. In this embodiment, the top section and sidewall of vessel cap 1 may be at least partly of stainless steel and double-walled, and the space between the cap's double walls may be vacuumized or otherwise insulated. Sleeve 5 encircles outer wall 3, and it may be at least partly of stainless steel and vacuumized or otherwise insulated. Inner wall 2 and outer wall 3 may be of stainless steel, and the space between them may be vacuumized or otherwise insulated so as to form an insulated double wall. As shown in FIG. 4A, the beverage in the vessel is completely insulated all around, and thermochromic ring 4 is covered by sleeve 5.

In FIG. 4B, sleeve 5 is lowered relative to inner wall 2 and outer wall 3, and thermochromic ring 4 is now revealed to view through gap 6. In this position, ring 4 indicates the temperature of the beverage inside the mug, and the beverage cools through the single-walled gap 6 created between the insulated sidewall of vessel cap 1 and insulated sleeve 5.

The embodiments described here are illustrative and not comprehensive of the embodiments contemplated by this invention. The thermochromic display has been described here as a ring near the top of the beverage container, but the thermochromic display may, in fact, be of any shape or size, and in any location. This invention has, by way of non-limiting example, described reversibly covering the thermochromic display by vessel cap or sleeve, but the invention encompasses the many means known to those skilled in the art for covering and revealing the thermochromic display. The method of moving the cap, sleeve, or other member to cover or uncover the thermochromic display can be by screw threads, cam-and-follower mechanism, sliding, snapping, press-fitting, or any of a number of other ways not listed here and commonly known to those skilled in the art. Though illustrated here as part of a stainless-steel double-walled vacuum-insulated travel mug, this invention encompasses beverage containers of any material with single walls or any number of walls, with or without insulation of any kind, configured as a travel mug or as a beverage container of any style. Though the thermochromic material specifically mentioned here was paint, this invention encompasses the use of thermochromic material of any suitable form, including (without limitation) thermochromic gel, paper, plastic, or other forms. Though described here as displaying two colors to signal a beverage temperature that is either “too hot” or “safe” for drinking, embodiments of this invention include those in which the thermochromic display projects a larger number of colors to represent a wider range of multiple precise temperature points.

Various characteristics, advantages, embodiments, and/or examples relating to the invention have been described in the foregoing description with reference to the accompanying drawings. However, the above description and drawings are illustrative only. The invention is not limited to the illustrated embodiments and/or examples, and all embodiments and/or examples of the invention need not necessarily achieve every advantage or purpose, or possess every characteristic, identified herein. Accordingly, various changes, modifications, or omissions may be effected by one skilled in the art without departing from the scope or spirit of the invention. Elements and uses of the above-described embodiments and/or examples can be rearranged and combined in manners other than specifically described above, with any and all permutations within the scope of the invention.

Unless the phrase ‘means for’ or ‘step for’ appears in a particular sample claim or sample claim limitation, such sample claim or sample claim limitation should not be interpreted to invoke 35 U.S.C. § 112(f).

Use of “and” herein to join elements in a list forms a group of all elements of the list. For example, a list described as comprising A, B, and C defines a list that includes A, includes B, and includes C. Use of “or” herein to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are inclusive, that is, lists are not limited to the stated elements and may be combined with other elements not specifically stated in a list.

The inventor hereby states an intent to rely on the Doctrine of Equivalents to determine and assess the reasonably fair scope of their invention as pertains to any apparatus not materially departing from but outside the literal scope of the invention as set out in the following claims.

We claim:

1. A system that indicates the temperature of beverage inside a beverage container comprising:
a container configured to hold a liquid to be consumed;
a thermochromic material in thermal contact with the liquid; and
a chromatic member configured to reversibly (a) cover and (b) expose the thermochromic material to external view when engaged by a user.

2. The system of claim 1 wherein said thermochromic material is reversibly attached.

3. The system of claim 1 further wherein a thermal member is configured to conduct thermal energy from an interior of the container to an exterior of the container without opening the liquid to the environment.

4. The system of claim 3 wherein said thermochromic material can be reversibly attached.

5. The system of claim 3 wherein the chromatic member and thermal member comprise the same component.

6. The system of claim 5 wherein said thermochromic material can be reversibly attached.

7. A system for accelerating the cooling of hot beverage inside a beverage container comprised by:
a container configured to hold a liquid to be consumed; and
a thermal member that reversibly enhances or reduces thermal insulation of the container by covering or exposing at least a portion of the container without opening the liquid to the external environment.

8. The system of claim 7 which is further comprised by:
a thermochromic material that is in thermal contact with the liquid; and
a chromatic member configured to reversibly (a) cover and (b) expose the thermochromic material to external view when engaged by a user.

9. The system of claim 8 wherein said thermochromic material can be reversibly attached.

10. The system of claim 8 wherein the chromatic member and thermal member comprise the same component.

11. The system of claim 10 wherein said thermochromic material can be reversibly attached.
